(19) United States
(12) Patent Application Publication
(10) Pub. No.: US 2011/0305132 A1
(43) Pub. Date: Dec. 15, 2011

(54) Management Of Air-Borne Vibration

(75) Inventors: Brian S. Merrow, Harvard, MA (US); Peter Miguel Martino, Windham, NH (US); Rhonda Lynn Allain, Newton, NH (US)

(73) Assignee: Teradyne, Inc.

(21) Appl. No.: 12/815,085

(22) Filed: Jun. 14, 2010

(51) Int. Cl. G11B 23/00

(52) U.S. Cl. 369/263.1; G9B/23

(57) ABSTRACT

A storage device testing system that includes a rack and a vibration management material. The rack includes at least one test slot that is configured to receive a storage device for testing. The test slot is substantially exposed to air on at least one side. The vibration management material is capable of absorbing and/or diffusing air-borne vibration. The vibration management material is disposed so as to attenuate air-borne vibration coupled to the test slot.

### TECHNICAL FIELD

This disclosure relates to management of air-borne vibrations, and particularly, to the management of air-borne vibrations in storage device testing systems.

### BACKGROUND

Storage devices, such as hard disk drives, are susceptible to vibration during operation and manufacturing. Moreover, hard disk drives can create vibration of their own during operation. To reduce the impact of vibration, hard disk drives are often mounted in a frame on soft isolators or springs during manufacture and test, to reduce the amount of vibration transmitted through the mechanical mounting.

Excess vibration can affect the reliability of test results and the integrity of electrical connections. Under test conditions, the drives themselves can propagate vibrations through supporting structures or fixtures to adjacent units. This vibration “cross-talking,” together with external sources of vibration, contributes to bump errors, head slap and non-repetitive run-out (NRRO), which may result in lower yields and increased manufacturing costs. Current disk drive testing systems employ automation and structural support systems that contribute to excess vibrations in the system and/or require large footprints.

During some manufacturing steps, the quality of servo tracks or other data recorded on the surface of the disk drive media is directly affected by the amount of vibration transmitted to the drive during the recording. The vibration may be transmitted through the mechanical mounting of a drive in a chassis, via the mechanical aspects of the electrical connection to the drive (e.g., through a cable), or through the air. Vibration transmission through the air may be acoustic or fluid in nature, and may transmit to the drive directly, or indirectly via intermediate mechanical connections.

Common sources of vibration in the air inside of a disk drive manufacturing system are system cooling fans; any cooling fans local to the disk drive; the motion of automation (if any); compressors, pumps, or other cooling components; and ambient noise from the rest of the factory. The vibration created by these sources is frequently broad-band in nature, thus affecting many of the operations of the disk drive.

### SUMMARY

In general, this disclosure relates to management of air-borne vibrations, and particularly, to the management of air-borne vibrations in storage device testing systems.

One aspect of the disclosure provides a storage device testing system that includes a rack and a vibration management material. The rack includes at least one test slot that is configured to receive a storage device for testing. The test slot is substantially exposed to air on at least one side. The vibration management material is capable of absorbing and/or diffusing air-borne vibration. The vibration management material is disposed so as to attenuate air-borne vibration coupled (e.g., acoustically coupled) to the test slot.

Implementations of the disclosure may include one or more of the following features.

In some implementations, the storage device testing system also includes an obstruction arranged within a path of air-borne vibration, and the vibration management material is applied to a surface of the obstruction. In some cases, the obstruction is another rack within the storage device testing system, automated machinery associated with the storage device testing system, or a structure enclosing the storage device testing system.

In some implementations, the vibration management material includes an absorber and/or a diffuser.

In certain implementations, the storage device testing system also includes a source of air-borne vibration. The source of air-borne vibration may be an air mover, a pump, a compressor, and/or an air conditioning vent.

In some implementations, the rack includes an exit, and at least one air mover configured to move an air flow out of the exit of the rack. The vibration management material may be disposed within a path of the air flow exhausted from the exit of the rack.

The storage device testing system may also include an air conduit in fluid communication with the at least one test slot, and the at least one air mover may be configured to move an air flow from the air conduit and towards the exit of the rack.

In certain implementations, the storage device testing system also includes a duct disposed along the exit of the rack and arranged to direct the air flow exhausted from the exit of the rack towards the vibration management material.

In some implementations, the vibration management material includes a diffuser that is disposed along the exit of the rack.

In certain implementations, the storage device testing system also includes an acoustic device (e.g., an audio speaker) arranged to cancel out air-borne vibrations.

Another aspect of the disclosure provides a storage device testing system that includes a rack and an acoustic device. The rack includes at least one test slot configured to receive a storage device for testing, an air conduit, an exit, and at least one air mover configured to move an air flow out of the exit of the rack. The acoustic device is arranged to cancel out air-borne vibrations originating from the at least one air mover.

Implementations of the disclosure may include one or more of the following features.

In certain implementations, the storage device testing system also includes an air conduit in fluid communication with the at least one test slot. The at least one air mover is configured to move an air flow from the air conduit and towards the exit of the rack.

In some implementations the acoustic device includes an audio speaker.

In certain implementations, the acoustic device is disposed along the exit of the rack.

A further aspect of the disclosure provides a storage device testing system that includes a source of air-borne vibration, and a vibration management material that is disposed within a path of air-borne vibration emanating from the source. The vibration management material is capable of absorbing and/or diffusing the air-borne vibration.

Implementations of the disclosure may include one or more of the following features.

In some implementations, the vibration management material includes a diffuser that is disposed adjacent the source of air-borne vibration.

In certain implementations, the vibration management material includes an absorber and/or a diffuser.

In certain implementations the storage device testing system also includes an obstruction arranged within a path of air-borne vibration emanating from the source of air-borne vibration and the vibration management material is applied to a surface of the obstruction. In some examples, the obstruction is a rack within the storage device testing system, automated machinery associated with the storage device testing system, or a structure enclosing the storage device testing system.

In some implementations, the storage device testing system includes an acoustic device arranged to cancel out air-borne vibrations emanating from the source.

In certain implementations, the source comprises an air mover, a pump, a compressor, and/or an air conditioning vent.

In some implementations, the storage device testing system includes a rack that includes at least one test slot configured to receive a storage device for testing, and the source is associated with (e.g., disposed within) the rack.

In certain implementations, the storage device testing system includes a duct arranged to direct an air flow exhausted from the source of air-borne vibration towards the vibration management material.

According to another aspect, a storage device testing system includes a source of air-borne vibration, and an acoustic device arranged to cancel out air-borne vibrations emanating from the source.

Implementations of the disclosure may include one or more of the following features.

In some implementations, the acoustic device includes an audio speaker.

In certain implementations, the acoustic device is disposed adjacent the source of air-borne vibration.

In yet another aspect, the disclosure provides a storage device testing system that includes a rack and a vibration management material. The rack includes at least one test slot that is configured to receive a storage device for testing. The vibration management material is disposed near the at least one test slot. The vibration management material is capable of absorbing and/or diffusing air-borne vibration.

The details of one or more implementations of the disclosure are set forth in the accompanying drawings and the description below. Other features, objects, and advantages will be apparent from the description and drawings, and from the claims.

### DESCRIPTION OF DRAWINGS

FIG. 1 is a perspective view of a storage device testing system having racks arranged in a substantially circular configuration.

FIG. 2 is a top view of the storage device testing system shown in FIG. 1.

FIG. 3 is a perspective view of a storage device testing system and a transfer station.

FIG. 4A is a side perspective view of a storage device transporter.

FIG. 4B is a front perspective views of the storage device transporter shown in FIG. 4A.

FIG. 4C is a bottom perspective views of a storage device transporter carrying a storage device.

FIG. 4D is a side perspective views of a storage device transporter receiving a storage device.

FIGS. 5A and 5B are perspective views of a test slot receiving a storage device transporter carrying a storage device.

FIG. 5C is a rear perspective view of a test slot.

FIGS. 6A and 6B are perspective views of a rack receiving a test slot carrier holding test slots.

FIGS. 7A and 7B are perspective views of a rack of a storage device testing system showing an air flow path through the rack and test slots housed by the rack.

FIGS. 8-10 illustrate passive techniques for attenuating and/or dispersing air-borne vibration in a storage device testing system.

FIG. 11 illustrates an active technique for canceling air-borne vibration in a storage device testing system.

FIGS. 12A and 12B illustrate storage device testing systems that includes an air conditioning vent as a source of air-borne vibration.

FIG. 13 illustrates a storage device testing system that includes a liquid pump as a source of air-borne vibration.

FIG. 14 illustrates a storage device testing system that includes a compressor-based air refrigeration unit as a source of air-borne vibration.

Like reference symbols in the various drawings indicate like elements.

### DETAILED DESCRIPTION

The vibration sensitivity of storage devices, such as hard disk drives, has increased to such an extent that transmission of vibrations through the air now has noticeable impact on performance. As will be discussed in detail, one or more passive vibration attenuation and/or dispersion techniques and/or active vibration cancellation techniques may be employed, e.g., near test slots of a test system, to reduce the effects of air-borne vibrations on the operation of the disk drives within a test system. “As used herein, “near” means near enough to effectively manage airborne vibration from one or more sources.

A storage device, as used herein, includes disk drives, solid state drives, memory devices, and any device that benefits from asynchronous testing for validation. A disk drive is generally a non-volatile storage device which stores digitally encoded data on rapidly rotating platters with magnetic surfaces. A solid-state drive (SSD) is a data storage device that uses solid-state memory to store persistent data. An SSD using SRAM or DRAM (instead of flash memory) is often called a RAM-drive. The term solid-state generally distinguishes solid-state electronics from electromechanical devices.

Air-borne vibration, as used herein, includes acoustic vibrations and fluid-borne vibrations, the latter sometimes known as wind.

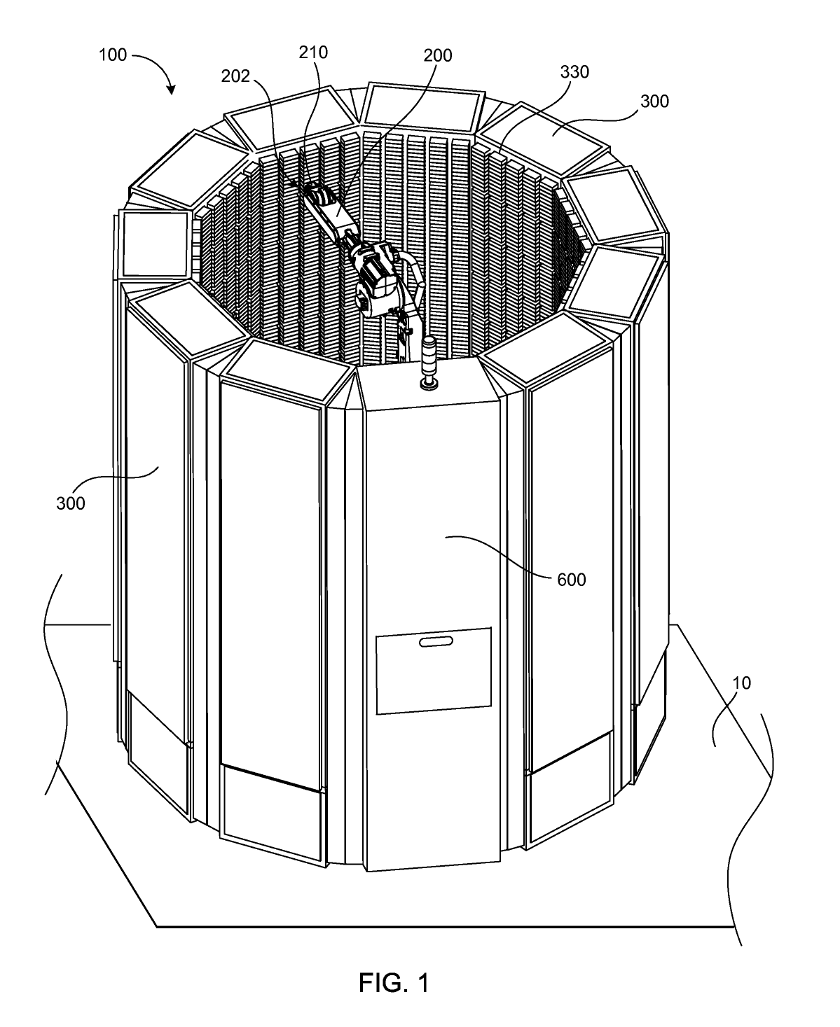

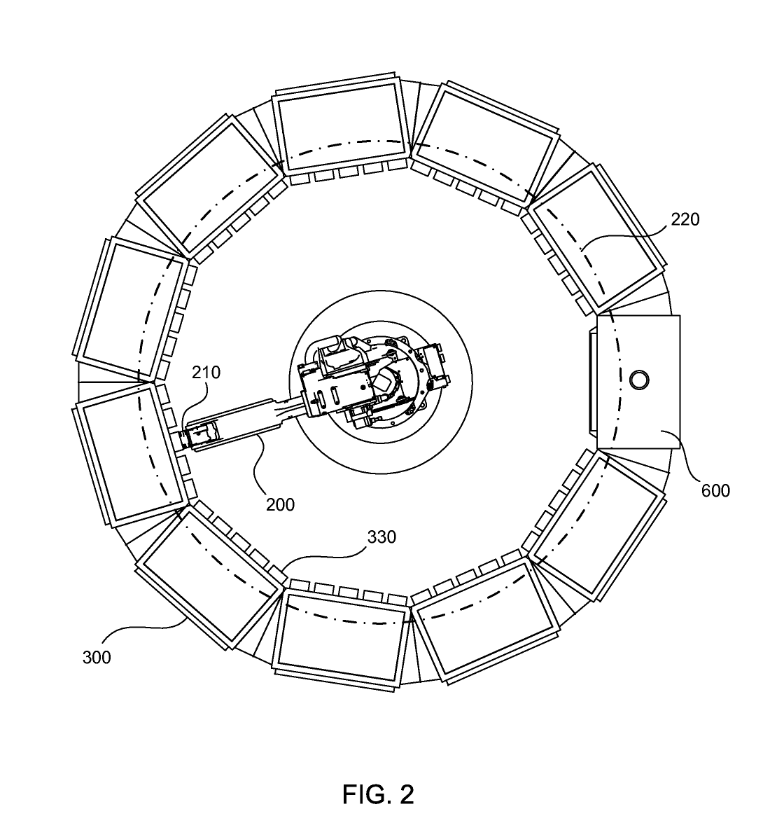

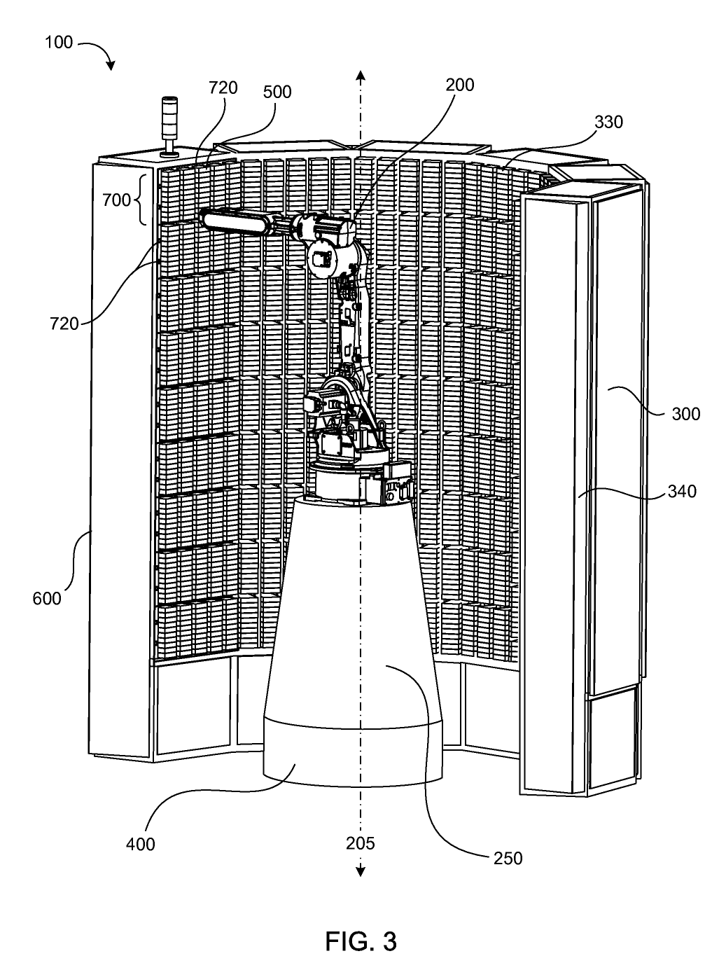

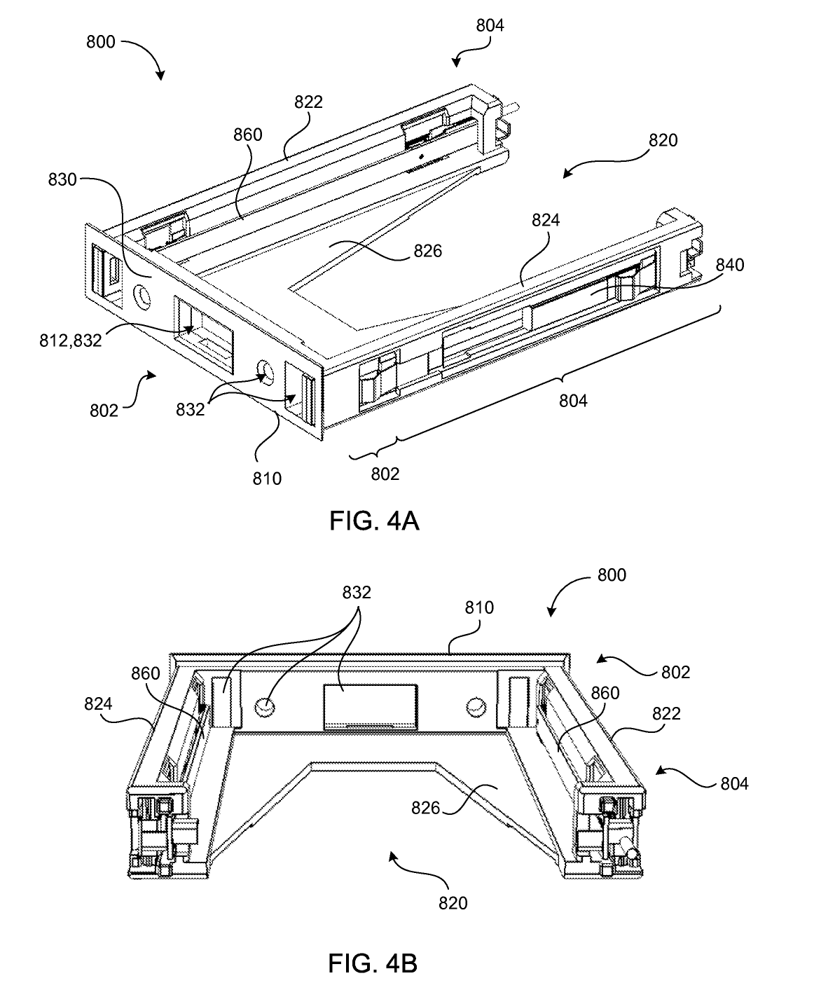

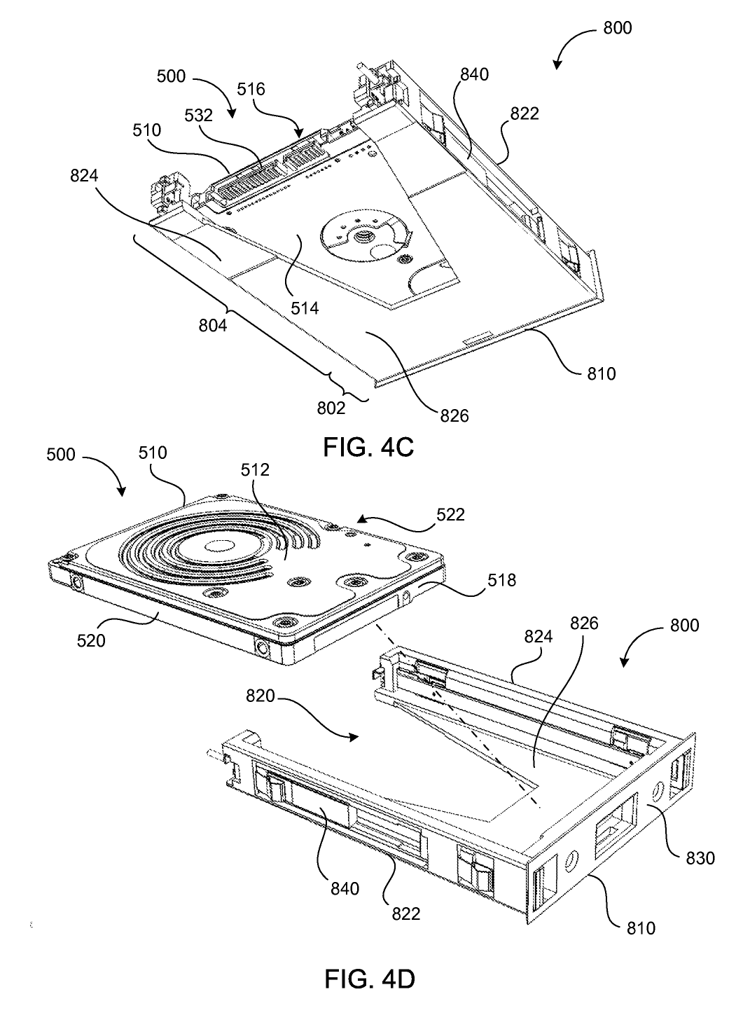

Referring to FIGS. 1-3, in some implementations, a storage device testing system 100 includes at least one automated transporter 200 (e.g. robot, robotic arm, gantry system, or multi-axis linear actuator) defining a first axis 205 (see FIG. 3) substantially normal to a floor surface 10. In the examples shown, the automated transporter 200 comprises a robotic arm 200 operable to rotate through a predetermined arc about the first axis 205 and to extend radially from the first axis 205. The robotic arm 200 is operable to rotate approximately 360° about the first axis 205 and includes a manipulator 210 disposed at a distal end 202 of the robotic arm 200 to handle one or more storage devices 500 and/or storage device transporters 800 to carry the storage devices 500 (see e.g., FIGS. 4A-4D). Multiple racks 300 are arranged around the robotic arm 200 for servicing by the robotic arm 200. Each rack 300 houses multiple test slots 330 configured to receive storage devices 500 for testing. The robotic arm 200 defines a substantially cylindrical working envelope volume 220, with the racks 300 being arranged within the working envelope 220 for accessibility of each test slot 330 for servicing by the robotic arm 200. The substantially cylindrical working envelope volume 220 provides a compact footprint and is generally only limited in capacity by height constraints. In some examples, the robotic arm 200 is elevated by and supported on a pedestal 250 on the floor surface 10. The pedestal 250 increases the size of the working envelope volume 220 by allowing the robotic arm 200 to reach not only upwardly, but also downwardly to service test slots 330. The size of the working envelope volume 220 can be further increased by adding a vertical actuator to the pedestal 250. A controller 400 (e.g., computing device) communicates with each automated transporter 200 and rack 300. The controller 400 coordinates servicing of the test slots 330 by the automated transporter(s) 200.

The robotic arm 200 is configured to independently service each test slot 330 to provide a continuous flow of storage devices 500 through the testing system 100. A continuous flow of individual storage devices 500 through the testing system 100 allows varying start and stop times for each storage device 500, whereas other systems that require batches of storage devices 500 to be run all at once as an entire testing loaded must all have the same start and end times. Therefore, with continuous flow, storage devices 500 of different capacities can be run at the same time and serviced (loaded/unloaded) as needed.

Referring to FIGS. 1-3, the storage device testing system 100 includes a transfer station 600 configured for bulk feeding of storage devices 500 to the robotic arm 200. The robotic arm 200 independently services each test slot 330 by transferring a storage device 500 between the transfer station 600 and the test slot 330. The transfer station 600 houses one or more totes 700 carrying multiple storage devices 500 presented for servicing by the robotic arm 200. The transfer station 600 is a service point for delivering and retrieving storage devices 500 to and from the storage device testing system 100. The totes 700 allow an operator to deliver and retrieve a collection of storage devices 500 to and from the transfer station 600. In the example shown in FIG. 3, each tote 700 is accessible from respective tote presentation support systems 720 in a presentation position and may be designated as a source tote 700 for supplying a collection of storage devices 500 for testing or as a destination tote 700 for receiving tested storage devices 500 (or both). Destination totes 700 may be classified as “passed return totes” or “failed return totes” for receiving respective storage devices 500 that have either passed or failed a functionality test, respectively.

In implementations that employ storage device transporters 800 (FIGS. 4A-4D) for manipulating storage devices 500, the robotic arm 200 is configured to remove a storage device transporter 800 from one of the test slots 330 with the manipulator 210, then pick up a storage device 500 from one the totes 700 presented at the transfer station 600 or other presentation system (e.g., conveyor, loading/unloading station, etc.) with the storage device transporter 800, and then return the storage device transporter 800, with a storage device 500 therein, to the test slot 330 for testing of the storage device 500. After testing, the robotic arm 200 retrieves the tested storage device 500 from the test slot 330, by removing the storage device transporter 800 carrying the tested storage device 500 from the test slot 330 (i.e., with the manipulator 210), carrying the tested storage device 500 in the storage device transporter 800 to the transfer station 600, and manipulating the storage device transporter 800 to return the tested storage device 500 to one of the totes 700 at the transfer station 600 or other system (e.g., conveyor, loading/unloading station, etc.).

As illustrated in FIGS. 4A-4D, the storage device transporter 800 includes a transporter body 810 having first and second portions 802, 804. The first portion 802 of the transporter body 810 includes a manipulation feature 812 (e.g., indention, protrusion, aperture, etc.) configured to receive or otherwise be engaged by the manipulator 210 for transporting. The second portion 804 of the transporter body 810 is configured to receive a storage device 500. FIGS. 4C-4D illustrate an exemplary storage device 500 that includes a housing 510 having top, bottom, front, rear, left and right surfaces 512, 514, 516, 518, 520, 522. The storage device 500 is typically received with its rear surface 518 substantially facing the first portion 802 of the storage device transporter body 810. The first portion 802 of the transporter body 810 includes an air director 830 defines at least one air entrance 832 (e.g., aperture, slot, etc.) for receiving air into the first portion 802 of the transporter body 810 and directing it out into the second portion 804 of the transporter body 800, such that the air can move over at least the top and bottom surfaces 512, 514 of the received storage device 500.

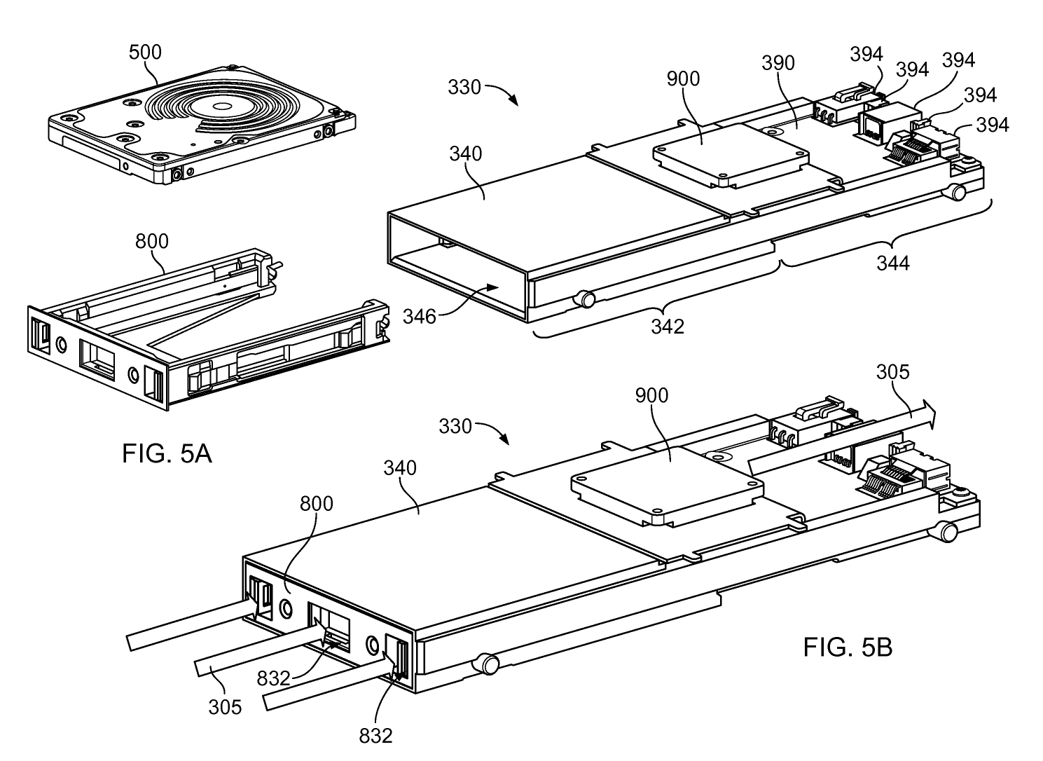

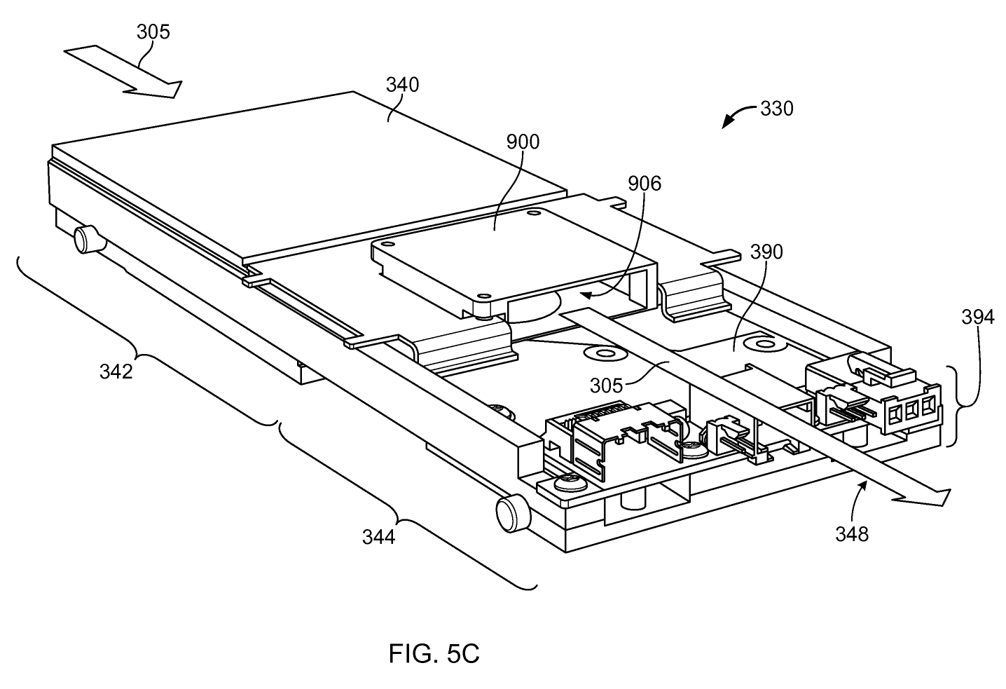

Referring to FIGS. 5A-5C, each test slot 330 includes a test slot housing 340. The test slot housing 340 has first and second portions 342, 344. The first portion 342 of the test slot housing 340 defines a device opening 346 sized to receive a storage device 500 and/or a storage device transporter 800 carrying the storage device 500. The second portion 344 of the test slot housing 340 includes an air exit 348, electronics 390 (e.g., circuit board(s)), and an optional air mover 900. The electronics 390 are in communication with a test slot connector 392, which is configured to receive and establish electrical communication with a storage device connector 532 of the storage device 500. The electronics 390 also include a slot-rack connector 394 for establishing electrical communication with the rack 300. Air moved through the test slot 300 can be directed over the electronics 390.

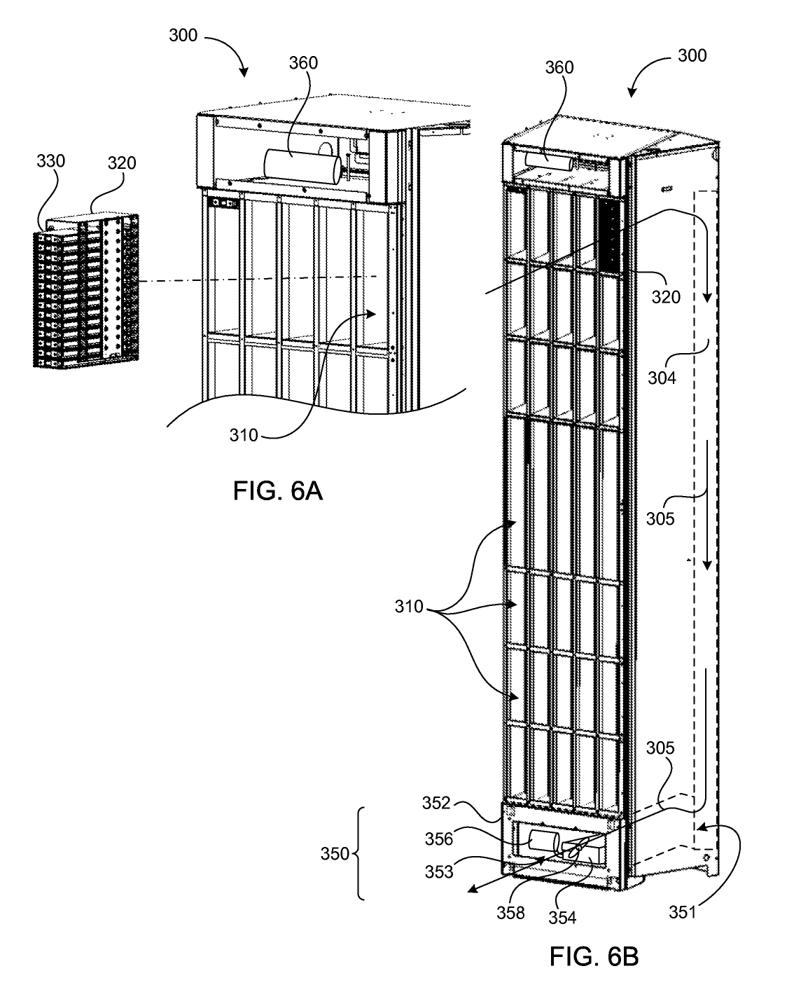

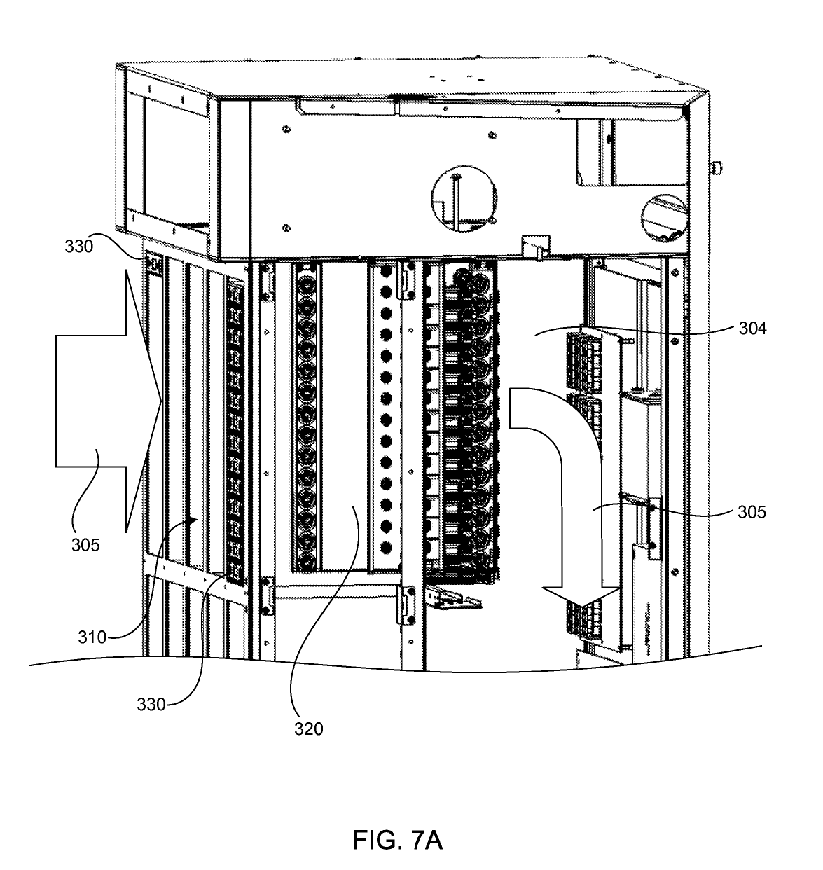

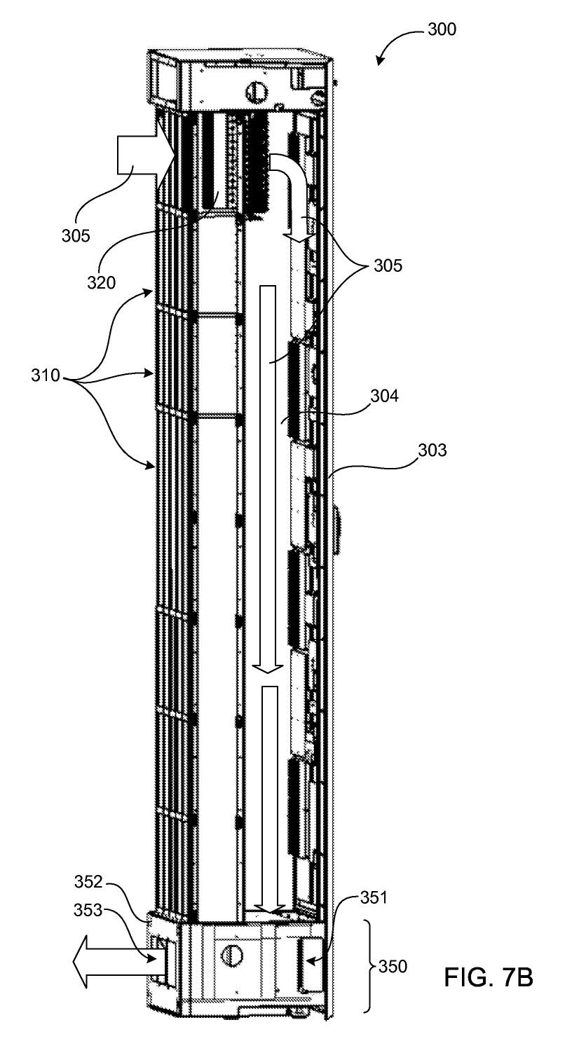

In the examples illustrated in FIGS. 6A and 6B, each rack 300 includes one or more carrier receptacles 310 each configured to receive a test slot carrier 320 that carries one or more test slots 330. Referring to FIG. 6B, each rack 300 also includes an air conduit 340 (also shown in FIGS. 7A and 7B) that provides pneumatic communication between each test slot 330 of the respective rack 300 and an exit 353 of the rack 300. In some implementations, the air conduit 304 is formed by a space between the test slots 330 and a rear wall 303 of the rack 300. The air conduit 304 can also be attached to an exterior of the rack 300, such as the wedge shaped conduit 304 shown in FIG. 6B.

In the example shown in FIG. 6B, the air conduit 304 (also shown in FIGS. 7A and 7B) provides pneumatic communication between each test slot 330 of the respective rack 300 and an air heat exchanger 350. The air heat exchanger 350 is disposed below the carrier receptacles 310 remote to received test slots 330. The air heat exchanger 350 includes an air heat exchanger housing 352 defining an entrance 351, an exit 353, and an air flow path 305 therebetween. In some implementations, cooling elements 354 are disposed in the housing 352 in the air flow path 305 and a pump 356 delivers condensation accumulated from the air heat exchanger 350 to an evaporator 360, which may be disposed on the respective rack 300 of the air heat exchanger 350 (e.g., above the carrier receptacles 310), or to a drain. The air heat exchanger 350 may include an air mover 358 that pulls the air from the air conduit 304 into the entrance 351 of the air heat exchanger housing 352 over the cooling elements 354, if implemented, and moves the air out of the air heat exchanger housing exit 353 and out of the rack 300.

FIGS. 7A-7B illustrate a flow path 305 of air through test slots 330 and a rack 300 for regulating the temperature of a storage device 500 received in the storage device testing system 100. The air mover 900 of each test slot 330 housed in the rack 300 helps to move a flow of air from an exterior space of the rack 300 into at least one entrance 832 of the air director 830 of a storage device transporter 800 received in the test slot 330. The air flow is directed substantially simultaneously over at least top and bottom surfaces 512, 514 of the storage device 500 received in the storage device transporter 800. The air mover 900 moves the air through the second portion 344 of the test slot housing 340 and out an air exit 348 (FIG. 5C) of the test slot 330 into the air conduit 304. The air moves through the air conduit 304 to the air heat exchanger 350 or the environment exterior to the rack 300. After passing through the air heat exchanger 350 the air is released back into the exterior space of the rack 300 via rack air mover 358 (FIG. 6B).

Air flow within the storage device testing system 100 may increase the vibration transmitted to storage devices 500 under test. As mentioned above, each rack 300 can include an air mover 358 that exhausts an airflow from the bottom of the rack. Obstructions may deflect the airflow back towards the rack, where the vibration caused by the air mover 358 may be transmitted to the storage devices, either directly, or indirectly by striking mechanical parts of the rack 300 that are coupled to the storage devices. Possible obstructions may include another one of the racks 300, automated machinery (e.g., the robotic arm 200 and/or the pedestal 250), a person walking by, a wall enclosing the system, or some other piece of structure or equipment in a factory.

To inhibit the transmission of air-borne vibrations to storage devices 500 being tested, one or more techniques may be employed to attenuate, cancel, and/or disperse air-borne vibrations inside of the storage device testing system 100. The attenuation or dispersion of air-borne vibration may be performed through passive techniques, such as the use of absorbing or dispersive materials, and/or through active techniques, such as active vibration cancellation.

### Passive Techniques

In some cases air-borne vibrations may be passively attenuated and/or dispersed by using vibration-diffusing and/or vibration-absorbing material in or near a storage device testing system. Vibration-absorbing materials attenuate the overall magnitude of a vibration over some range of frequencies, and vibration-diffusing materials reduce the incidence and magnitude of nodes in the system, where constructive interference increases the local magnitude of a vibration. An example, of vibration-absorbing material is Studiofoam®, available from Auralex Acoustics. An example of a commercially vibration diffusing material is Q'Fusor Sound Diffusor, available from Auralex Acoustics. Placement of one or both of these materials in or near the storage device testing system can absorb or scatter various frequencies of air-borne vibration. Selection of material type and/or placement allows one to tune the amount and frequency of the vibration to be reduced. Areas of constructive interference may be reduced, or may be relocated to more benign locations, or both.

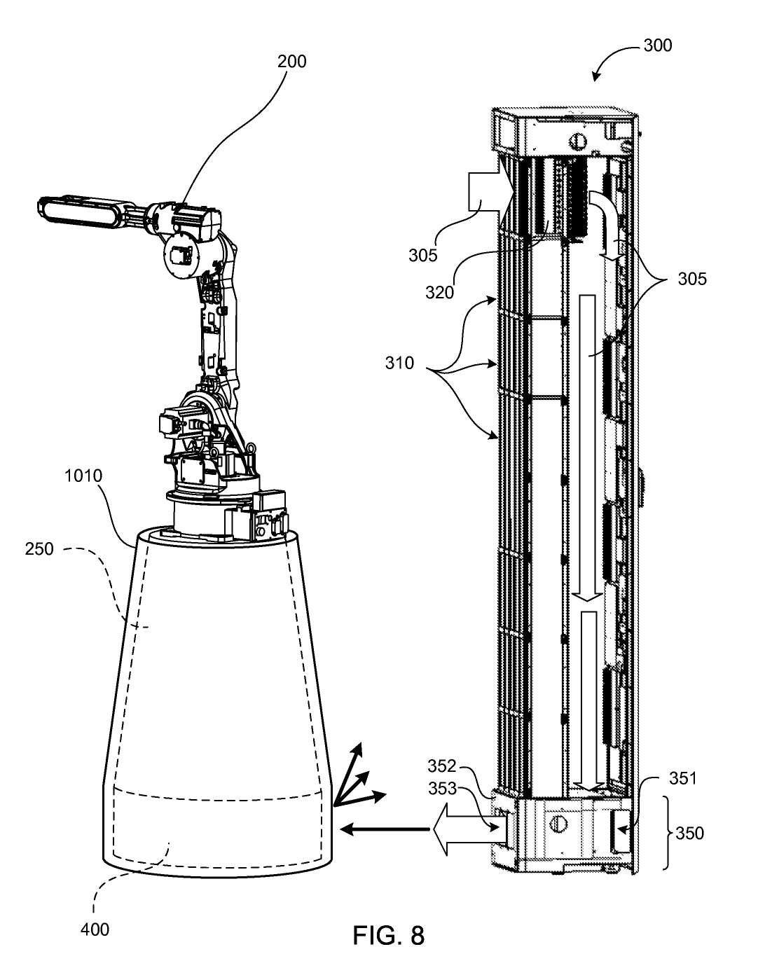

FIG. 8 illustrates an implementation in which a vibration management material 1010 (e.g., an absorber, diffuser, or combination thereof) is applied to the surface of an obstruction. In this case, the obstruction is shown as the pedestal 250 for the robotic arm 200. This material 1010 either absorbs the air-borne vibration emanating from the exit 353 of the heat exchanger housing 352, or diffuses it in several directions, or both. Absorption will reduce the magnitude of the vibration over some frequency range, whereas diffusion will scatter the air around the system, reducing the magnitude of air-borne vibration in any given place, and reducing the likelihood of the formation of areas of significant constructive interference. Alternatively or additionally, the shape and/or material of the obstruction could be designed so it is inherently an absorber, diffuser, or both, without the application of a separate material for this purpose.

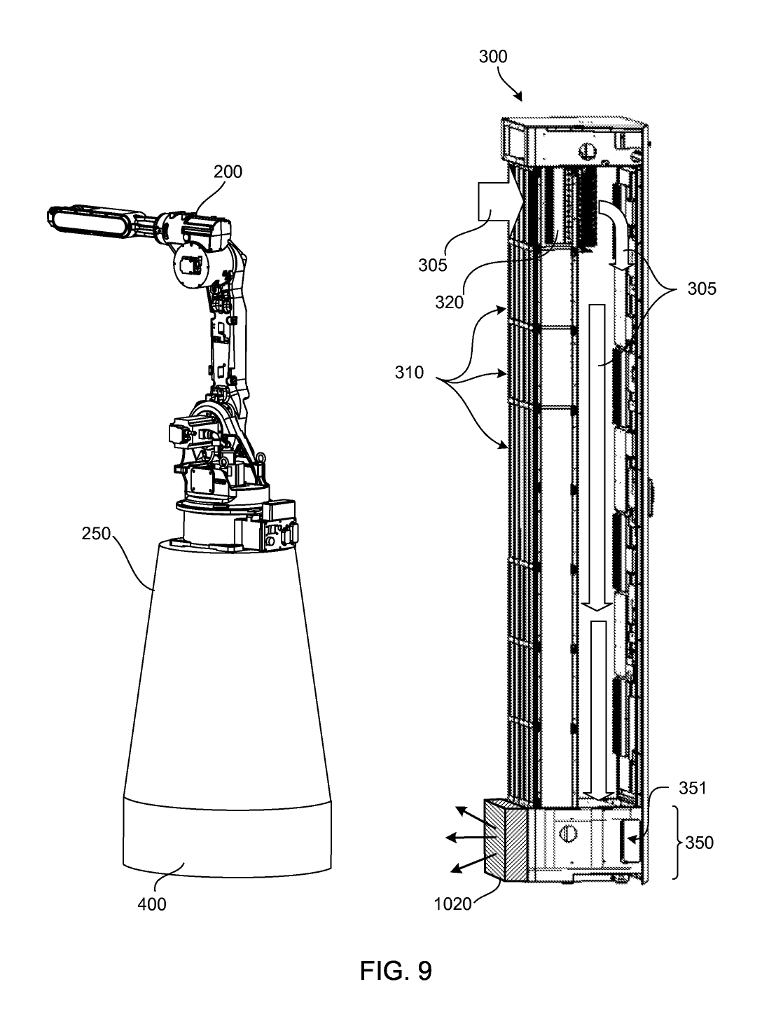

FIG. 9 illustrates another implementation, which may be used, for example, where the nature of the obstruction is unknown or variable. Instead of treating the obstruction with some material to absorb or diffuse air-borne vibration, a diffuser 1020 is placed near the source of the vibration. This also has the advantage of diffusing both reflected and non-reflected vibration, e.g., vibration through an air flow that flows straight up in FIG. 9.

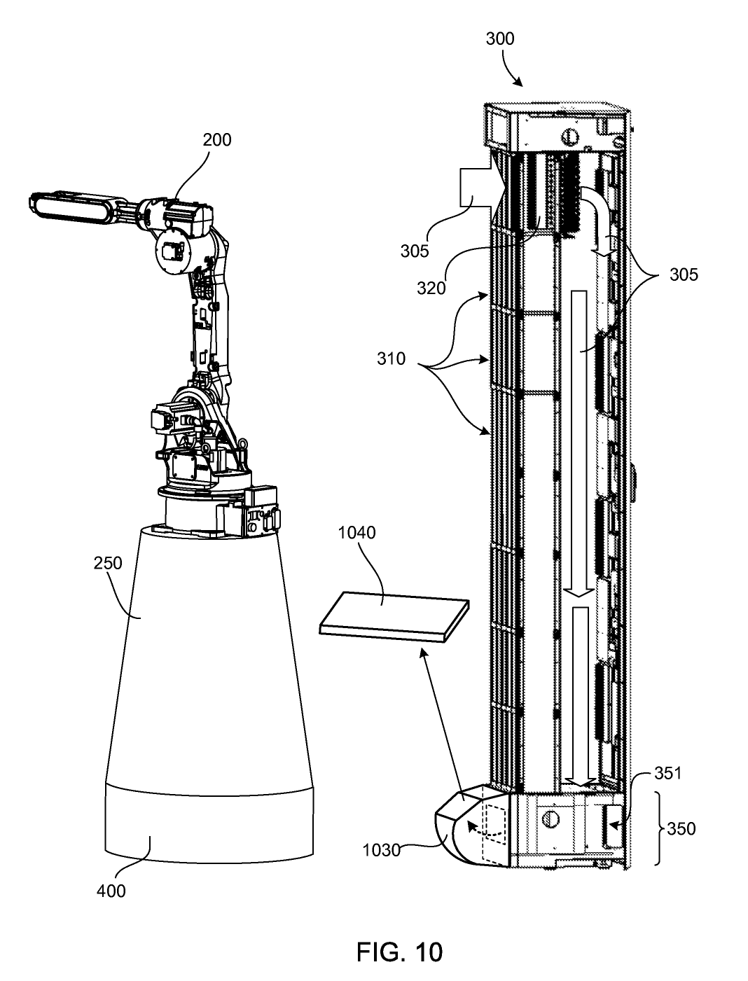

FIG. 10 illustrates an example of how airflow may be ducted so it causes less transmission of vibration to storage devices under test. In this example, the airflow is directed more directly upwards via a duct 1030, so as to minimize the reflections off the obstruction.

FIG. 10 also shows an alternative placement of a vibration management material 1040 (e.g., an absorber, diffuser, or combination thereof) in the direct path of the air flow. By placing multiple such elements in the air path, with none of them completely blocking the path, the velocity of air flow can be reduced while the diffusion and absorption of vibration can be increased. Care can be taken so as not to cause any new undesirable reflections.

Combinations of the implementations depicted in FIGS. 8-10 are also possible. One could, for example combine a diffuser as in FIG. 9 with an absorber placed as in FIG. 8. Other implementations are also possible.

Furthermore, while implementations shown depict a single rack with one or more storage devices, and a single air mover 358 (e.g., fan) as the source of vibration, there may be multiple vibration sources, including but not limited to surrounding automation (e.g., the robotic arm 200), other storage devices, and ambient acoustical noise and air flow. There may also be other surfaces or structures that can reflect the vibration, just as there may be multiple direct paths for the vibration. As mentioned above, the vibration may be acoustical or fluid-borne (wind) in nature, or both.

### Active Techniques

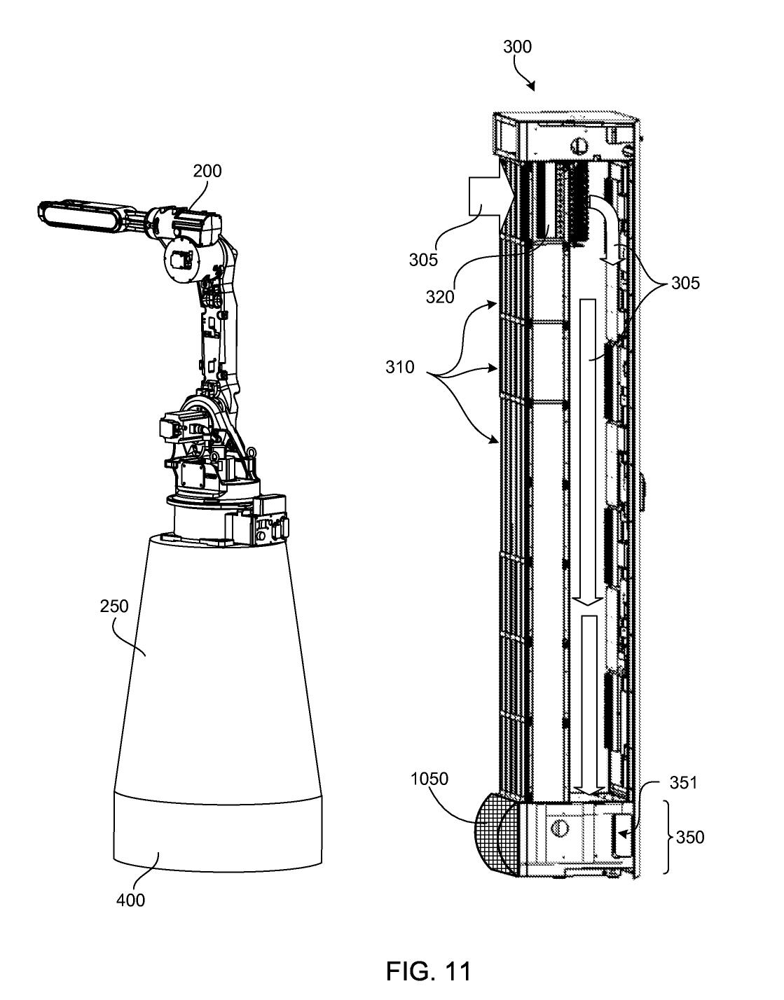

FIG. 11 illustrates an implementation that includes the addition of active vibration cancellation near the source (air mover 358 (FIG. 6B)). In this case, the frequency spectrum and phase of the noise source is either previously known, or is actively measured, and a 180° out of phase air flow is generated, for example using an acoustic device 1050 (e.g., an audio speaker) to cancel out the vibration. This technique can also be combined with any of the passive techniques discussed above.

A number of implementations have been described. Nevertheless, it will be understood that various modifications may be made without departing from the spirit and scope of the disclosure.

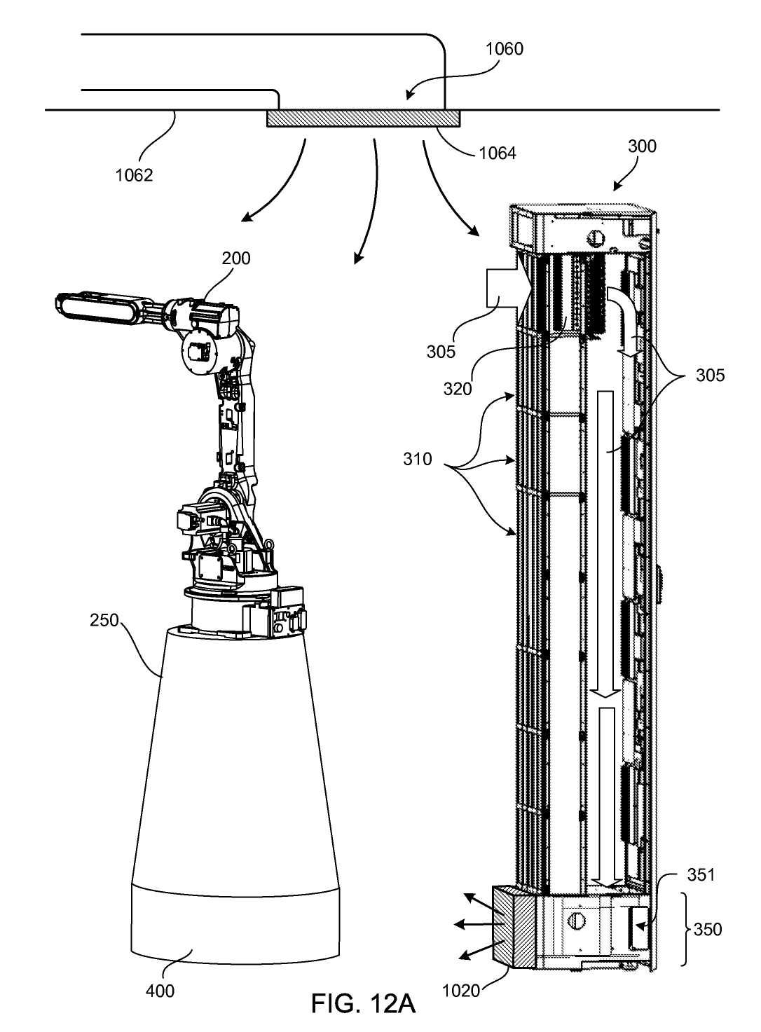

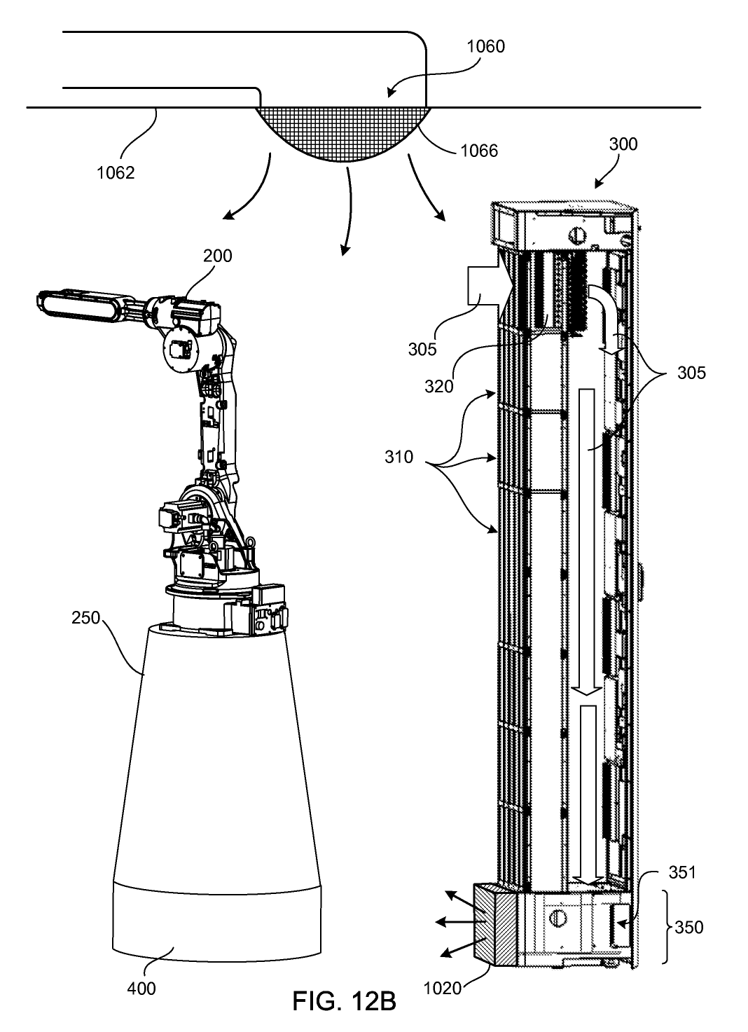

For example, with reference to FIGS. 12A and 12B, some storage device testing systems may circulate ambient air through the system. To maintain the temperature of the ambient air, the storage device testing system may be placed near air conditioning vents 1060, in the floor, walls, or ceiling 1062 of a room housing the storage device testing system. The air exiting the air conditioning vent 1060 may be a carrier of air-borne vibration originating from elsewhere in the building. As illustrated in FIG. 12A, a vibration management material 1064 (e.g., an absorber and/or a diffuser) may be provided to absorb and/or diffuse air-borne vibration emanating from the air conditioning vent 1060. Alternatively or additionally, an acoustic device 1066 (e.g., an audio speaker) may be provided to cancel out the air-borne vibration emanating from the air conditioning vent 1060, as illustrated in FIG. 12B.

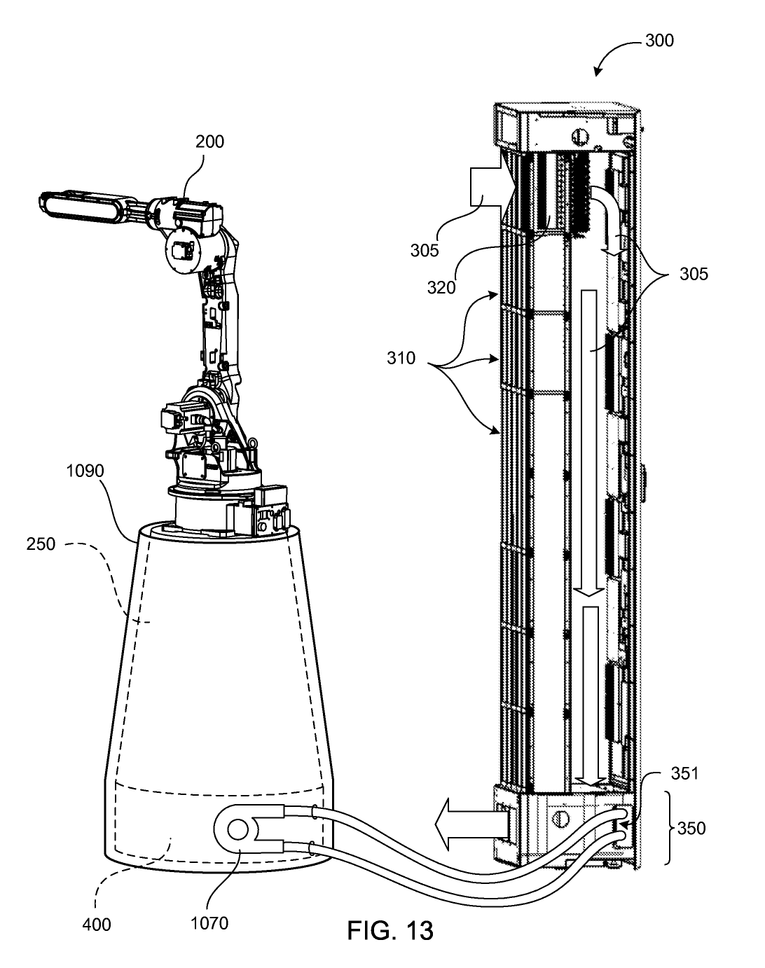

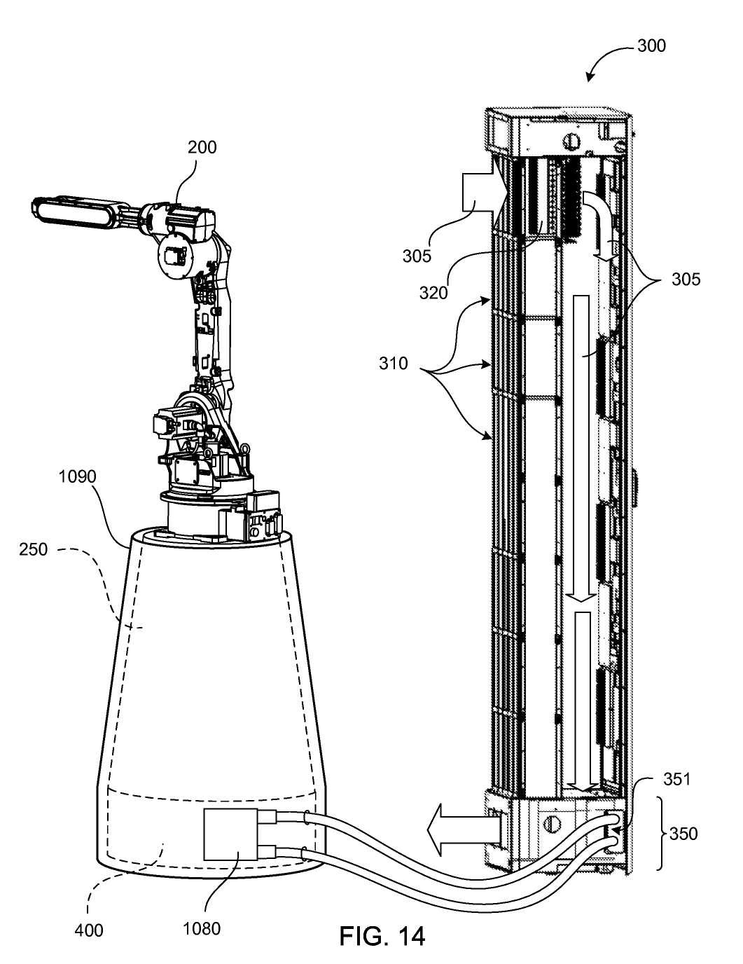

Some storage device testing systems may include a chilled water cooling system, which may include a pump 1070, as illustrated in FIG. 13, to circulate the water within the system. Other storage device testing systems may include a compressor-based air refrigeration unit 1080, as illustrated in FIG. 14. Both the pump 1070 and the compressor-based air refrigeration unit 1080 within such storage device testing systems may be sources of air-borne vibration. As illustrated in FIGS. 13 and 14, a vibration management material 1090 (e.g., an absorber and/or a diffuser) may be provided to absorb and/or diffuse air-borne vibration emanating from the pump 1070 or the compressor-based air refrigeration unit 1080.

Accordingly, other implementations are within the scope of the following claims.

What is claimed is:

1. A storage device testing system comprising:
a rack comprising at least one test slot configured to receive a storage device for testing, wherein the test slot is substantially exposed to air on at least one side; and
a vibration management material capable of absorbing and/or diffusing air-borne vibration, wherein the vibration management material is disposed so as to attenuate air-borne vibration coupled to the test slot.

2. The storage device testing system of claim 1, further comprising an obstruction arranged within a path of air-borne vibration, wherein the vibration management material is applied to a surface of the obstruction.

3. The storage device testing system of claim 2, wherein the obstruction is another rack within the storage device testing system, automated machinery associated with the storage device testing system, or a structure enclosing the storage device testing system.

4. The storage device testing system of claim 1, wherein the vibration management material comprises a diffuser.

5. The storage device testing system of claim 1, wherein the vibration management material comprises an absorber and/or a diffuser.

6. The storage device testing system of claim 1, further comprising a source of air-borne vibration.

7. The storage device testing system of claim 6, wherein the source of air-borne vibration comprises an air mover, a pump, a compressor, and/or an air conditioning vent.

8. The storage device testing system of claim 1,
wherein the rack comprises an exit, and at least one air mover configured to move an air flow out of the exit of the rack, and
wherein the vibration management material is disposed within a path of the air flow exhausted from the exit of the rack.

9. The storage device testing system of claim 8, further comprising a duct disposed along the exit of the rack and arranged to direct the air flow exhausted from the exit of the rack towards the vibration management material.

10. The storage device testing system of claim 8, wherein the vibration management material comprises a diffuser disposed along the exit of the rack.

11. The storage device testing system of claim 1, further comprising an acoustic device arranged to cancel out air-borne vibrations.

12. A storage device testing system comprising:
a source of air-borne vibration; and
a vibration management material disposed within a path of air-borne vibration emanating from the source, wherein the vibration management material is capable of absorbing and/or diffusing the air-borne vibration.

13. The storage device testing system of claim 12, wherein the vibration management material comprises an absorber and/or a diffuser.

14. The storage device testing system of claim 12, further comprising an obstruction arranged within a path of air-borne vibration emanating from the source of air-borne vibration, wherein the vibration management material is applied to a surface of the obstruction.

15. The storage device testing system of claim 14, wherein the obstruction is a rack within the storage device testing system, automated machinery associated with the storage device testing system, or a structure enclosing the storage device testing system.

16. The storage device testing system of claim 12, further comprising an acoustic device arranged to cancel out air-borne vibrations emanating from the source.

17. The storage device testing system of claim 12, wherein the source comprises an air mover, a pump, a compressor, and/or an air conditioning vent.

18. The storage device testing system of claim 12, further comprising a rack including at least one test slot configured to receive a storage device for testing, wherein the source is associated with the rack.

19. The storage device testing system of claim 12, further comprising a duct arranged to direct an air flow exhausted from the source of air-borne vibration towards the vibration management material.

20. A storage device testing system comprising:
a source of air-borne vibration;
an acoustic device arranged to cancel out air-borne vibrations emanating from the source.

21. The storage device testing system of claim 20, wherein the acoustic device comprises an audio speaker.

22. The storage device testing system of claim 20, wherein the acoustic device is disposed adjacent the source of air-borne vibration.
